(19) United States
(12) Patent Application Publication
(10) Pub. No.: US 2007/0093564 A1
(43) Pub. Date: Apr. 26, 2007

(54) Foam containing nanoparticles and process for producing a foam

(76) Inventors: David G. Wernsing, Littleton, CO (US); Angela R. Bratsch, Monument, CO (US)

Correspondence Address: JOHNS MANVILLE, 10100 WEST UTE AVENUE, LITTLETON, CO, 80127, US

(21) Appl. No.: 11/257,944

(22) Filed: Oct. 25, 2005

(51) Int. Cl. C08J 9/00

(52) U.S. Cl. 521/82

(57) ABSTRACT

Provided is a foam suitable for use as a thermal insulation material, comprising a foam matrix comprising a polyisocyanurate and/or a polyurethane, and a plurality of nanoparticles present in the foam matrix. Also provided is a process for producing a foam suitable for use as a thermal insulation material, comprising mixing at least an A-component with a B-component to form a foam comprising a polyisocyanurate and/or a polyurethane, wherein a plurality of nanoparticles is present in the foam.

### BACKGROUND

Rigid foam products can be formed using various conventional processes. The thermal insulation characteristics of such foam products are generally important, and various techniques can be used to provide suitable thermal insulation properties. For example, blowing agents which have relatively low vapor thermal conductivity properties are conventionally used in the production of such foam products. The low vapor thermal conductivity properties of the blowing agents can contribute to good thermal insulation characteristics in the foam products. Blowing agents which can be used include, for example, CFC-11, CCl₃F and HCFC-141b, CCl₂FCH₃.

Currently, the use of such compounds and other similar compounds as blowing agents, has been restricted by governmental regulations. While various compounds which meet governmental regulations have been proposed as potential replacement blowing agents, these compounds generally exhibit higher vapor thermal conductivity properties. The use of such compounds exhibiting higher vapor thermal conductivity properties can have an adverse effect on the thermal insulation characteristics of foam products formed therefrom.

In view of the above, it would be beneficial to provide a foam product having good thermal insulation properties while at the same time, for example, decreasing or avoiding the need of certain blowing agent compounds.

### SUMMARY

According to one aspect, a foam suitable for use as a thermal insulation material is provided, comprising:

a foam matrix comprising a polyisocyanurate and/or a polyurethane, and

a plurality of nanoparticles present in the foam matrix.

According to another aspect, a process for producing a foam suitable for use as a thermal insulation material is provided, comprising:

mixing at least an A-component with a B-component to form a foam comprising a polyisocyanurate and/or a polyurethane, wherein a plurality of nanoparticles is present in the foam.

### DETAILED DESCRIPTION OF THE PREFERRED EMBODIMENTS

The foam includes a foam matrix and a plurality of nanoparticles present in the foam matrix. As used herein, the term “nanoparticle” refers to a particle which has at least one dimension that is 100 nanometers or less, preferably 50 nanometers or less, and more preferably 10 nanometers or less. In an exemplary embodiment, each dimension of the nanoparticle (for example, length, height, and width) is 100 nanometers or less, preferably 50 nanometers or less, and more preferably 10 nanometers or less. For example, the nanoparticles can have dimensions which are from about 1 to about 100 nanometers, preferably from about 1 to about 50 nanometers, and more preferably from about 1 to about 10 nanometers.

The nanoparticles are not particularly limited in shape. For example, the nanoparticles can have a substantially plate-like shape and/or a substantially spherical shape. Alternatively, at least some or all of the nanoparticles can have a substantially random, asymmetrical shape.

While not wishing to be bound to any particular theory, it is believed that the inclusion of the nanoparticles in at least one of the components used. in the foam-forming reaction, and particularly in a process for forming a polyurethane and/or polyisocyanate, can lead to an improvement in the thermal insulation characteristics of the foam. For example, the nanoparticles can function as nucleating agents during the manufacture of the foam, and the use of the nanoparticles can lead to the formation of a closed cellular structure in which the cell size is relatively small. It is believed that the relatively small cell size can contribute to improved thermal insulation characteristics of the foam product.

The nanoparticles can be formed from any material that is capable of being made into nanoparticle-sized particles, and which material would not adversely impact the foam. The nanoparticles can be formed from a single material or a mixture of different materials. In an exemplary embodiment, the nanoparticles can comprise nanoclay particles such as montimorillonite particles (approximately Al₂O₃.4SiO₂.H₂O). For example, surface-modified montimorillonite particles which can be used are available under the trade name Nanomer I.30E nanoclay from Nanocor Inc. located in Arlington Heights, Ill. Other nanoparticles that can be used include, for example, nanoparticles made from carbon such as carbon nanotubes.

The composition of the nanoparticles can be substantially homogeneous, and/or the nanoparticles can have at least one layer formed around a core. While the use of the nanoparticles can impart beneficial characteristics to the foam, the material(s) from which the nanoparticles are formed can be chemically inert with respect to the foam-forming reaction. The material used to form the nanoparticles preferably does not substantially hinder the formation of the foam. Preferably, the nanoparticles are formed from a material that is capable of being dispersed in a component to which the nanoparticles are added, more preferably substantially evenly dispersed in the component without requiring the use of a dispersing agent.

The nanoparticles can contain a coating to impart desirable characteristics to the particles. For example, the nanoparticles can be surface-treated with an anti-agglomeration agent for reducing or preventing the formation of nanoparticle agglomerates in the foam.

The foam can be formed using any suitable amount of the nanoparticles, wherein the amount used can depend on, for example, the desired thermal insulation characteristics of the foam. Preferably, the amount of nanoparticles used is sufficient to improve the thermal insulation characteristics of the foam without substantially adversely affecting the foam-forming process. For example, the nanoparticles can be present in an amount of less than about 10%, more preferably from about 0.01% to about 5%, and most preferably from about 0.1% to about 1% based on the weight of the foam. While the use of too small an amount of nanoparticles may not be effective to impart desirable characteristics to the foam, the use of an excessive amount of nanoparticles can have an adverse effect on the foam-forming process.

The foam matrix is the material in which the nanoparticles are present. The foam matrix can be formed from a polyurethane and/or a polyisocyanurate which is effective to provide thermal insulation. The foam matrix is preferably formed from a rigid material, for example, the foam matrix can be sufficiently rigid to be a self-supporting material.

The polyurethane and/or polyisocyanurate of the foam matrix can be formed using any suitable method. For example, the foam matrix can be formed by mixing at least two components such as an A-component and a B-component, wherein the A-component and B-component contain reactants in a reaction for forming the foam. For example, in the case of the formation of a polyisocyanurate, the A-component can contain at least an isocyanate compound and the B-component can contain at least a polyol. Additional ingredients can be included in either or both of the two components, and/or in at least one additional component, for example, a “C-component”.

The nanoparticles can be employed in the foam-forming process, for example, in a manner which enables the nanoparticles to function as nucleating agents during the formation of the foam. For example, the nanoparticles can be included in at least one of the components used to form the foam. Preferably, the nanoparticles can be included in the A-component, the B-component, the optional C-component, or combinations thereof. Inclusion of the nanoparticles in one of the above components can enable the nanoparticles to be present during the intimate mixing of such components, which can in turn enable the nanoparticles to function as nucleating agents during formation of the foam.

The A-component and B-component (and any additional optional components) can be mixed together by using any suitable process and equipment, and the components can be mixed simultaneously or in any suitable sequence. The A-component containing, for example, an isocyanate can be supplied by any suitable means such as a metering unit or a metering pump. The B-component which contains, for example, a polyol, an expansion agent, a catalyst and a surfactant, can be prepared in a mix tank, and can be supplied by any suitable means such as a metering unit or a metering pump. The metering units or pumps are capable of providing a flow of the components at an elevated pressure, and controlling the flow of the components to a precise ratio in light of the desired chemistry.

The flows of the A-component and B-component can be provided to at least one foam mix head. Inside the mix head, the flows of the components can be ejected at an elevated pressure of, for example, from about 2000 psi to about 2500 psi. The pressurized flows can be impinged against each other, resulting in the intimate mixing of the components. In an exemplary embodiment, the mix head can include two nozzles arranged facing each other, for example about one quarter inch apart from each other. Pressurized flows of the components are emitted from the nozzles and collide with each other, thereby resulting in the mixing of the components. At least one conduit feeds the flow of a component to each nozzle. The conduit can have a relatively small diameter, for example, about one sixteenth inch or less. While not wishing to be bound by any particular theory, it is believed that the use of nanoparticles in the above-described system of conduits and nozzles, in comparison with larger-sized particles, can reduce or prevent the occurrence of clogging of the conduits and/or the nozzles.

The resulting mixture can then be applied to a substrate in which the foam is formed. The amount of the mixture applied to the substrate and the rate at which it is applied can depend on the desired dimensions and characteristics of the foam. The properties, dimensions and characteristics of the foam can depend on the specific intended application, and can be varied by controlling the contents of the components and/or the parameters of the reaction process. For example, for insulation applications, the foam can have a density of from about 1.3 to about 2.0 lbs. per cubic foot. The foam can be provided in any suitable form, for example, in the form of a sheet.

The A-component includes at least one reactive compound for forming the foam matrix. For example, the A-component can include at least an isocyanate compound. Any organic polyisocyanate can be employed in the preparation of the foam. For example, the organic polyisocyanate can include aromatic, aliphatic and cycloaliphatic polyisocyanates and combinations thereof. Such polyisocyanates are described, for example, in U.S. Pat. Nos. 4,795,763, 4,065,410, 3,454,606, 3,152,162, 3,492,330, 3,001,973, 3,394,164 and 3,124,605, the contents of which are incorporated herein by reference. Exemplary polyisocyanates include diisocyanates such as m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, diphenyl methane-4,4′-diisocyanate, 4,4′-diphenylenediisocyanate, 3,3′-dimethoxy-4,4′-biphenyl-diisocyanate, 3,3′-dimethyldiphenylmethane-4,4′-diisocyanate; triisocyanates such as 4,4′,4″-triphenylmethane-triisocyanate, polymethylenepolyphenyl isocyanate, toluene-2,4,6-triisocyanate; and tetraisocyanates such as 4,4′dimethyldiphenylmetlhane-2,2′,5,5′-tetraisocyanate. Mixtures of the above polyisocyanates can also be used.

The isocyanate can include, for example, Mondur 489 (Bayer), Rubinate 1850 (ICI), Luprinate M70R (BASF) or Papi 580 (Dow). Isocyanate indices greater than about 200 can be used, particularly from about 225 to about 325.

The B-component includes at least one reactive compound for reaction with the A-component to form the foam matrix. For example, the B-component can include at least an organic compound containing at least 1.8 or more isocyanate-reactive groups per molecule. Preferably, the isocyanate-reactive compound is a polyol such as a polyester and/or polyether polyol. Such polyester and polyether polyols are described, for example, in U.S. Pat. No. 4,795,763, the contents of which are herein incorporated by reference. The polyester polyols can be prepared by known procedures from a polycarboxylic acid or acid derivative, such as an anhydride or ester of the polycarboxylic acid, and a polyhydric alcohol. The acids and/or the alcohols can be used as mixtures of two or more compounds in the preparation of the polyester polyols.

The polycarboxylic acid component, which is preferably dibasic, can be aliphatic, cycloaliphatic, aromatic and/or heterocyclic and can optionally be substituted, for example, by halogen atoms, and/or may be unsaturated. Examples of suitable carboxylic acids and derivatives thereof for the preparation of the polyester polyols include: oxalic acid; malonlic acid; succinic acid; glutaric acid; adipic acid; pimelic acid; suberic acid; azelaic acid; sebacic acid; phthalic acid; isophthalic acid; trimellitic acid; terephthalic acid; phthalic acid anhydride; tetrahydrophthalic acid anhydride; pyromellitic dianhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dibasic and tribasic unsaturated fatty acids optionally mixed with monobasic unsaturated fatty acids, such as oleic acid; terephthalic acid dimethyl ester and terephthalic acid-bis-glycol ester.

Any suitable polyhydric alcohol can be used in preparing the polyester polyols. The polyols can be aliphatic, cycloaliphatic, aromatic and/or heterocyclic, and are preferably selected from the group consisting of diols, triols and tetrols. Aliphatic dihydric alcohols having no more than about 20 carbon atoms can be used. The polyols optionally can include substituents which are inert in the reaction, for example, chlorine and bromine substituents, and/or may be unsaturated. Suitable amino alcohols, such as, for example, monoethanolamine, diethanolamine, triethanolamine, or the like can also be used. Moreover, the polycarboxylic acid(s) may be condensed with a mixture of polyhydric alcohols and amino alcohols.

Examples of suitable polyhydric alcohols include ethylene glycol; propylene glycol-(1,2) and -(1,3); butylene glycol-(1,4) and -(2,3); hexanediol-(1,6); octane diol-(1,8); neopentyl glycol; 1,4-bishydroxymethyl cyclohexane; 2-methyl-1,3-propane diol; glycerin; trimethylolpropane; trimethylolethane; hexane triol-(1,2,6); butane triol-(1,2,4); pentaerythritol; quinitol; mannitol; sorbitol; formitol; alpha-methyl-glucoside; diethylene glycol; triethylene glycol; tetraethylene glycol and higher polyethylene glycols; dipropylene glycol and higher polypropylene glycols as well as dibutylene glycol and higher polybutylene glycols. Especially suitable polyols are oxyalkylene glycols, such as diethylene glycol, dipropylene glycol, triethylene glycol, tripropylene glycol, tetraethylene glycol, tetrapropylene glycol, trimethylene glycol and tetramethylene glycol.

Particularly preferred polyester polyols include Stepanpol PS2352 (Stepan) and Terate 2541 (Hoechst Celanese). Preferred amounts of the polyester polyols are consistent with isocyanate indices greater than 200, preferably between about 225 and 325.

Polyether polyols can include the reaction products of a polyfunctional active hydrogen initiator and a monomeric unit such as ethylene oxide, propylene oxide, butylene oxide and mixtures thereof, preferably propylene oxide, ethylene oxide or mixed propylene oxide and ethylene oxide. The polyfunctional active hydrogen initiator preferably has a functionality of 2-8, and more preferably has a functionality of 3 or greater (e.g., 4-8).

A wide variety of initiators can be alkoxylated to form useful polyether polyols. For example, poly-functional amines and alcohols of the following type may be alkoxylated: monoethanolamine, diethanolamine, triethanolamine, ethylene glycol, polyethylene glycol, propylene glycol, hexanetriol, polypropylene glycol, glycerine, sorbitol, trimethylolpropane, pentaerythritol, sucrose and other carbohydrates. Such amines or alcohols may be reacted with the alkylene oxide(s) using techniques known to those skilled in the art. The hydroxyl number which is desired for the finished polyol would determine the amount of alkylene oxide used to react with the initiator. The polyether polyol may be prepared by reacting the initiator with a single alkylene oxide, or with two or more alkylene oxides added sequentially to give a block polymer chain or at once to achieve a random distribution of such alkylene oxides. Polyol blends such as a mixture of high molecular weight polyether polyols with lower molecular weight polyether polyols can also be employed.

Any suitable blowing agent can be employed in the foam compositions. In general, these blowing agents are liquids having a boiling point between −50 degrees C. and 100 degrees C. and preferably between 0 degrees C. and 50 degrees C. The blowing agent can include a hydrocarbon or a halohydrocarbon such as chlorinated and fluorinated hydrocarbons. Suitable blowing agents include HCFC-141b (1-chloro-1,1-difluoroethane), HCFC-22 (monochlorodifluoromethane), HFC-245 fa (1,1,1,3,3-pentafluoropropane), HFC-134a (1,1,1,2-tetrafluoroethane), HFC-365mfc (1,1,1,3,3-pentafluorobutane), cyclopentane, normal pentane, isopentane, LBL-2(2-chloropropane), trichlorofluoromethane, CCl₂ FCClF₂, CCl₂ FCHF₂, trifluorochloropropane, 1-fluoro-1,1-dichloroethane, 1,1,1-trifluoro-2,2-dichloroethane, methylene chloride, diethylether, isopropyl ether, methyl formate, carbon dioxide and mixtures thereof. Blowing agents can also be used which have a higher vapor thermal conductivity property in comparison with the blowing agents listed above.

Any suitable surfactant can be employed in the foam including, for example, silicone/ethylene oxide/propylene oxide copolymers. The surfactant can include, for example, polydimethylsiloxane-polyoxyalkylene block copolymers available from Witco Corporation under the trade names “L-5420”, “L-5340”, and Y10744; from Air Products under the trade name “DC-193”; from Goldschmidt under the name, Tegostab B84PI; and Dabco DC9141. Other suitable surfactants which can be used are described in U.S. Pat. Nos. 4,365,024 and 4,529,745, the contents of which are herein incorporated by reference. The surfactant can comprise from about 0.05% to 10%, and preferably from about 0.1% to 6%, based on the weight of the component to which it is added.

The foam containing nanoparticles can be used in various applications including, for example, as a thermal insulation material. The dimensions of the foam are not particularly limited, and can depend on the specific application of the foam, for example, the dimensions of the space to be insulated. The foam can be incorporated in a rigid insulation product, and more particularly a rigid boardstock such as the boardstock disclosed in U.S. Pat. No. 6,140,383, the contents of which are herein incorporated by reference.

While a detailed description of specific exemplary embodiments has been provided, it will be apparent to one of ordinary skill in the art that various changes and modification can be made, and equivalents employed without departing from the scope of the claims.

1. A foam suitable for use as a thermal insulation material, comprising:
a foam matrix comprising a polyisocyanurate and/or a polyurethane, and
a plurality of nanoparticles present in the foam matrix.

2. The foam according to claim 1, wherein the plurality of nanoparticles comprises montmorillonite particles.

3. The foam according to claim 1, wherein each nanoparticle comprises a coating comprising an anti-agglomeration agent.

4. The foam according to claim 1, wherein the plurality of nanoparticles is present in an amount from about 0.01% to about 5%, by weight of the foam.

5. The foam according to claim 4, wherein the plurality of nanoparticles is present in an amount from about 0.1% to about 1%, by weight of the foam.

6. A process for producing a foam suitable for use as a thermal insulation material, comprising:
mixing at least an A-component with a B-component to form a foam comprising a polyisocyanurate and/or a polyurethane, wherein a plurality of nanoparticles is present in the foam.

7. The process for producing a foam according to claim 6, wherein the A-component comprises an isocyanate and the B-component comprises a polyol.

8. The process for producing a foam according to claim 6, wherein prior to the mixing step, the A-component and/or the B-component comprises the plurality of nanoparticles.

9. The process for producing a foam according to claim 6, wherein a C-component is mixed with the A-component and the B-component, and wherein the C-component comprises the plurality of nanoparticles.

10. The process for producing a foam according to claim 6, wherein the mixing step comprises directing a pressurized flow of the A-component at a pressurized flow of the B-component.

11. The process for producing a foam according to claim 10, wherein the A-component and/or the B-component comprises the plurality of nanoparticles prior to the mixing step.

12. The process for producing a foam according to claim 10, wherein each pressurized flow is ejected at a pressure of from about 2000 psi to about 2500 psi.

13. The process for producing a foam according to claim 6, wherein the plurality of nanoparticles comprises montmorillonite particles.

14. The process for producing a foam according to claim 6, wherein each nanoparticle comprises a coating comprising an anti-agglomeration agent.

15. The process for producing a foam according to claim 6, wherein the plurality of nanoparticles is present in an amount from about 0.01% to about 5%, by weight of the foam.

16. The process for producing a foam according to claim 14, wherein the plurality of nanoparticles is present in an amount from about 0.1% to about 1%, by weight of the foam.
